(19) United States
(12) Patent Application Publication
(10) Pub. No.: US 2026/0025903 A1
(43) Pub. Date: Jan. 22, 2026

(54) APPARATUS AND METHODS FOR PURGING COOLING LIQUID CONDUITS IN A PLASMA ARC TORCH

(71) Applicant: The ESAB Group Inc., North Bethesda, MD (US)

(72) Inventor: Andrew John Raymond, Lebanon, NH (US)

(21) Appl. No.: 18/774,002

(22) Filed: Jul. 16, 2024

(51) Int. Cl. H05H 1/28; B23K 10/00; H05H 1/34

(52) U.S. Cl. CPC H05H 1/28; B23K 10/00; H05H 1/34

(57) ABSTRACT

Plasma arc cutting assemblies and methods that facilitate the purging of liquid from a cooling system that functions to cool components of a torch during a cutting operation. One aspect includes delivering a process gas into the cooling system to purge from it the liquid coolant. This is achieved by coupling a process gas source with a coolant supply conduit and delivering process gas into the coolant supply conduit through one or more control valves situated between the process gas source and the coolant supply conduit. Process gas from the gas source may be simultaneously delivered into a process gas flow channel of the torch during the purging process. Monitoring a liquid coolant level in a storage tank into which the liquid coolant flows may occur during the purging process, with an automatic closing of the one or more control valves occurring when a high liquid coolant level is detected.

### FIELD

The present invention pertains to the field of liquid cooled plasma arc cutting torches.

### BACKGROUND

FIG. 1 is a simplified illustration of a distal end portion of a plasma torch 20 known in the art. FIG. 1 illustrates the plasma torch without various components or parts, such as power or gas transfer components, that are typically included in a plasma cutting torch. The torch includes a number of consumable parts, such as, for example, an electrode 23, a nozzle 24, and a shield cap 25. Located in a distal end portion of the electrode 23 is an emitter 29. The electrode 23 can be installed into the torch body and the torch nozzle 24 can be installed there over. Alternatively, the electrode 23 and nozzle 24 can be installed onto the torch body as a single component (e.g., these components may be coupled to each other to form a cartridge and installed on/in the torch body as a cartridge). Located in a space between the electrode 23 and the nozzle 24 is an arc chamber 26.

Once the electrode 23 and the nozzle 24 are installed on the torch body, the shield cap 25 is installed around an installation flange of the nozzle 24 in order to secure nozzle 24 and electrode 23 in place at (and in axial alignment with) an operating end of the torch body. Additionally or alternatively, the nozzle 24 and/or electrode 23 can be secured or affixed to the torch body in any desirable manner, such as by mating threaded sections included on the torch body with corresponding threads included on the components. For example, the electrode 23, nozzle 24, shield cap 25, as well as any other components (e.g., a lock ring, spacer, secondary cap, etc.) may be assembled together in a cartridge that may be selectively coupled to the torch body. For example, the various components may be coupled to a cartridge body or coupled to each other to form a cartridge.

In use, the plasma torch 20 is configured to emit a plasma arc 34 between the electrode 23 and a workpiece 40 to which a work lead associated with a power supply is attached. As shown in FIG. 1, the nozzle 24 is spaced a distance away from the electrode 23 with there being a process gas flow channel 30 disposed between them through which process gas 32 flows when the torch is operated. The shield cap 25 is also spaced a distance away from the nozzle 24 with there being a shield gas flow channel 31 disposed between them through which a shield gas 33 flows when the torch is operated.

During initiation, a high voltage and high frequency signal is applied between the electrode 23 and the nozzle 24 to produce an arc between them that extends across the process gas flow passage through which pilot gas is supplied. In some instances, the process gas is the pilot gas As pilot gas flows through channel 30 during arc initiation it is ionized to form an electrically conductive plasma arc that is then directed out the nozzle 24 toward the electrically conductive workpiece 40 (e.g. metal workpiece). Upon the plasma arc transferring to the workpiece 40, main cutting current is thereafter supplied to the electrode 23 and an electrical circuit is established between the power source and the workpiece with plasma gas/process gas 32 being provided through the process gas flow channel. A plasma arc 34 that closes the electrical circuit is thus established between the electrode 23 and the workpiece, the plasma arc being sufficient to cut through the workpiece by a localized melting of the material from which the workpiece is made.

During operation, torch components, such as the electrode 23, are cooled by circulating cooling water through the torch 20. At the time one or more of the consumable parts or a cartridge is changed, cooling liquid (e.g. water) retained in the torch head can flow into the arc chamber 26 and other parts of the torch head and has the potential to damage these parts of the torch head. The changing of parts also leads to a loss of liquid coolant.

As shown in FIG. 2, cooling water ingress and egress channels, respectively 27 and 28, may be provided inside the electrode 23 to provide a liquid coolant flow path indicated by the arrows depicted in the figure. Although not shown, cooling liquid supply and return channels are also commonly provided inside the nozzle 24.

### SUMMARY

According to some implementations a plasma arc cutting assembly is provided that includes a torch configured to be outfitted with a detachable consumable part. The consumable part includes therein a coolant channel through which a liquid coolant flows during a plasma arc cutting operation. The torch also includes a process gas flow channel that is configured to deliver a process gas into an arc chamber of the torch to maintain a stream of plasma. The assembly also includes a coolant supply conduit through which the liquid coolant is delivered to the coolant channel and a coolant return conduit through which the liquid coolant flows upon exiting the coolant channel. A first control valve located on a gas line that extends at least partially between a process gas source and the process gas flow channel, the first control valve being configured to control flow of process gas into the process gas flow channel. The gas line includes a first conduit located downstream an outlet of the first control valve. A second control valve is located between a second conduit and a third conduit and is transitional between an open position and a closed position. The second conduit fluidly couples the first conduit to an inlet of the second control valve, while the third conduit couples an outlet of the second control valve to the coolant supply conduit.

According to some implementations, upon there being a flow of process gas through the first control valve while the second control valve is in the open position, the process gas flows respectively through at least a portion of the coolant supply conduit, the coolant channel, and the coolant return conduit while simultaneously flowing to the process gas flow channel of the torch and into the arc chamber.

According to one implementation a plasma arc cutting assembly is provided that includes a torch configured to be outfitted with one or more detachable consumable parts of which at least one consumable part has disposed therein a coolant channel through which a liquid coolant flows during a plasma arc cutting operation. The coolant channel may include an ingress channel through which the liquid coolant enters the consumable part and an egress channel through which the liquid coolant is directed out of the consumable part. According to some implementations, the consumable part includes an electrode having a distal end located inside a nozzle with there being an arc chamber located in a space between the electrode and nozzle. There also exists a process gas flow channel located between an external surface of the electrode and a surface of the nozzle that is configured to deliver a process gas into the arc chamber.

According to some implementations, the coolant ingress and egress channels are connectable to a circulation system that includes a coolant supply conduit through which the liquid coolant is delivered to the ingress channel and a coolant return conduit into which the liquid coolant flows upon exiting the egress channel. The coolant supply and return conduits are typically and respectively in fluid communication with an outlet and an inlet of a liquid coolant storage tank.

As noted above, it is beneficial to remove liquid coolant, such as water, from the torch before the removal of the consumable part from the torch. According to one aspect, this is achieved by delivering pressurized process gas into the coolant supply conduit such that the process gas flows respectively through the coolant supply conduit, ingress channel, egress channel and coolant return conduit. According to one implementation, process gas from a pressurized process gas source is delivered into and guided through the torch cooling system through the use of one or more control valves and a set of strategically placed check valves.

According to some implementations, a first control valve is disposed between first and second conduits with the first conduit being located between the process gas source and an inlet of the first electronic valve and the second conduit being located between an outlet of the first control valve and the process gas flow channel. The first control valve is configured to control the flow of process gas into the process gas flow channel. Further, a second control valve is disposed between third and fourth conduits with the third conduit coupling the second conduit to an inlet of the second control valve and the fourth conduit coupling an outlet of the second control valve to the coolant supply conduit. One or both of the first and second control valves is configured to assume both an open position and a closed position to respectively permit and preclude flow therethrough. According to one implementation the first control valve is a proportional valve and the second control valve is an electromagnetic valve (e.g. solenoid valve).

Upon each of the first and second control valves being in an open position, the process gas flows respectively through at least a portion of the coolant supply conduit, the ingress channel, the egress channel, and the coolant return conduit with the process gas simultaneously flowing into the process gas flow channel of the torch.

According to any of the implementations disclosed herein, the plasma arc cutting assembly may further include 1) a first check valve located in the fourth conduit that only permits flow in the direction of the coolant supply conduit, 2) a second check valve located in the coolant supply conduit upstream a coupling location of the fourth conduit with the coolant supply conduit, the second check valve only permitting flow in the direction of the ingress channel, and 3) a third check valve located in the coolant return conduit, the third check valve only permitting flow in a direction away from the egress channel. According to some implementations there is interposed in the coolant supply conduit a coolant pump that is configured to produce liquid coolant flow in the direction of the ingress channel. According to some implementations the coolant pump is located upstream the second check valve.

According to any of the implementations disclosed herein, a liquid coolant high level sensor may be coupled to or reside in the liquid coolant storage tank and configured to activate a switch upon a liquid coolant level in the tank achieving a high threshold level. When activated during a liquid coolant purging operation, the switch (which may be a part of the sensor) is operative to cause a closure of at least the second control valve to cease the flow of process gas into the coolant supply conduit. For example, according to some implementations, the switch is positioned in a circuit between a power source and the second control valve and is transitional between an open and closed position. When a high level is sensed by the high level sensor during a liquid coolant purging operation, the switch is caused to transition from a closed position to an open position to terminate the flow of current to the second control valve. This causes the second control valve to assume the closed position to terminate the liquid coolant purging operation.

According to other implementations, like disclosed above, the first control valve is disposed between first and second conduits with the first conduit being located between the process gas source and an inlet of the first control valve and the second conduit being located between an outlet of the first control valve and the process gas flow channel of the torch. The first control valve is configured to control the flow of process gas into the process gas flow channel. Also like disclosed above, the second control valve is disposed between third and fourth conduits, however the third conduit couples the inlet of the second control valve to the process gas source and the fourth conduit couples the outlet of the second control valve to the coolant supply conduit. This implementation differs from the implementation disclosed above in that the process gas delivered to the inlet of the second control valve does not first flow through the first control valve.

According to some implementations, during a cutting operation the first control valve is maintained in an open position to deliver process gas into the arc chamber of the torch and the second control valve is maintained closed. However, during a time period after the cutting operation has terminated and before a torch consumable is changed, the coolant pump is turned off and at least the second control valve is opened to cause a flow of process gas through the liquid coolant circulation system in a manner like that discussed above. That is, the process gas flows respectively through at least a portion of the coolant supply conduit, the ingress channel, the egress channel, and the coolant return conduit.

According to some implementations, upon or after the completion of the cutting operation, the first control valve is closed to terminate process gas flow into the process gas flow channel of the torch. The closing of the first control valve may occur before or after the opening of the second control valve.

These and other advantages and features will become apparent in view of the figures and detailed description.

### BRIEF DESCRIPTION OF THE DRAWINGS

FIG. 1 shows a cross-section view of a portion of a prior art plasma arc cutting torch.

FIG. 2 shows a cross-section view of a prior art plasma arc cutting torch electrode having disposed therein a liquid coolant channel.

FIG. 3 is a schematic of a plasma arc cutting assembly according to one implementation.

FIG. 4 is a schematic of a plasma arc cutting assembly according to another implementation.

FIG. 5A is an electrical schematic showing a switch disposed between a power source and actuators of process gas flow control valves, the switch being in a closed position.

FIG. 5B is an electrical schematic similar to that shown in FIG. 5A with the switch in an open position.

### DETAILED DESCRIPTION

Examples of plasma arc cutting assemblies are described below with reference to the accompanying figures.

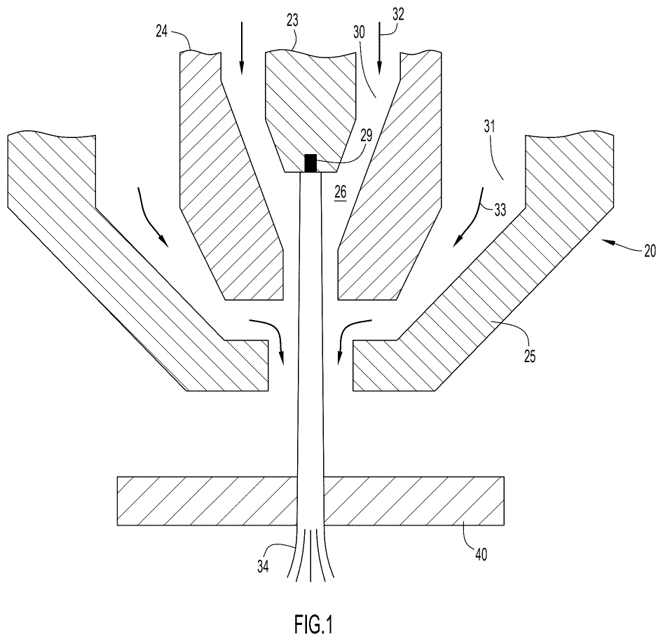

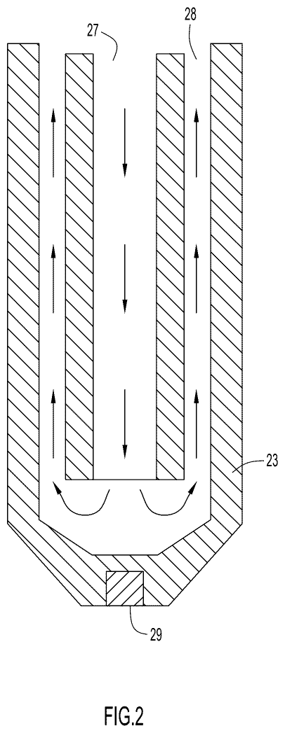

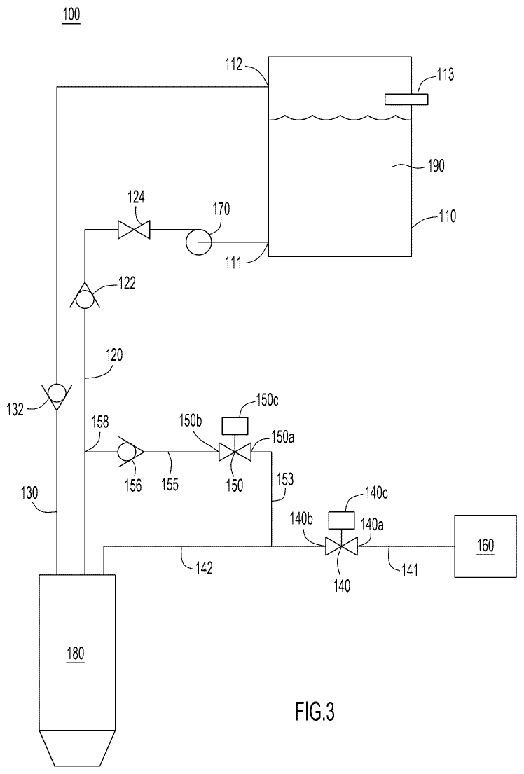

FIG. 3 is a schematic of a plasma arc cutting assembly 100 according to one implementation. The assembly includes a torch 180 that may have the same or similar features as the torch 20 described above in reference to FIG. 1. The torch 180 may have an electrode 23 similar in construction to that shown in FIG. 2, having an internal coolant channel through which liquid coolant 190 flows at least when a welding operation is in progress. The coolant channel includes the coolant ingress channel 27 through which the liquid coolant enters the electrode 23 and the coolant egress channel 28 through which the liquid coolant is directed out of the electrode.

The coolant ingress channel 127 and coolant egress channel 128 are connectable to a liquid coolant circulation system that includes a coolant supply conduit 120 through which the liquid coolant 190 is delivered to the ingress channel 27 and a coolant return conduit 130 into which the liquid coolant flows upon exiting the egress channel. The coolant supply and return conduits 120 and 130 are typically and respectively in fluid communication with an outlet 111 and an inlet 112 of a liquid coolant storage tank 110. According to some implementations a manually or electronically actuated shutoff valve 124 is disposed in the coolant supply conduit 120 which can be closed to prevent the passage of process gas into the storage tank 110 during a time a liquid coolant purging operation is underway. As discussed below, in lieu of the use of valve 124, or in combination with its use, a one-way check valve 122 may be provided in the coolant supply conduit 120 to prevent the process gas from entering the tank 110 during the purging operation.

As noted above, it is beneficial to remove the liquid coolant 190, such as water, from the torch before the removal of a consumable part from the torch. According to one aspect, this is achieved by delivering pressurized process gas into the coolant supply conduit 120 such that the process gas flows respectively through the coolant supply conduit 120, ingress channel 127, egress channel 128 and coolant return conduit 130. According to one implementation, process gas from a pressurized process gas source 160 is delivered into and guided through the torch cooling system through the use of one or more control valves 140, 150 and a set of strategically placed check valves 122, 132, 156.

According to some implementations, a first control valve 140 is disposed between a first conduit 141 and a second conduit 142 with the first conduit being located between the process gas source 160 and an inlet 140a of the first electronic valve 140. The second conduit 142 is located between an outlet 140b of the first control valve 140 and the process gas flow channel 30 of the torch 180. The first control valve 140 is configured to control the flow of process gas into the process gas flow channel 30 of the torch. Further, a second control valve 150 is disposed between a third conduit 153 and a fourth conduit 155 with the third conduit 153 coupling the second conduit 142 to the inlet 150a of the second control valve 150 and the fourth conduit 155 coupling the outlet 150b of the second control valve 150 to the coolant supply conduit 120. One or both of the first and second control valves is configured to assume both an open position and a closed position to respectively permit and preclude flow therethrough. According to one implementation the first control valve 140 is a proportional valve and the second control valve 150 is an electromagnetic shut-off valve (e.g. solenoid valve). Alternatively, one or both of control valves 140 and 150 may be manually operated valves.

Upon each of the first and second control valves 140 and 150 being in an open position, the process gas flows respectively through at least a portion of the coolant supply conduit 120, the ingress channel 127, the egress channel 128, and the coolant return conduit 130 with the process gas simultaneously flowing into the process gas flow channel 30 of the torch 180.

According some implementations the plasma arc cutting assembly includes first, second and third check valves, 156, 122 and 132. The first check valve 156 is located in the fourth conduit 155 and only permits flow in the direction of the coolant supply conduit 120. The second check valve 122 is located in the coolant supply conduit 120 upstream a coupling location 158 of the fourth conduit 155 with the coolant supply conduit 120, the second check valve only permitting flow in the direction of the coolant ingress channel 127 of the torch electrode 23. The third check valve 132 is located in the coolant return conduit 130 and only permits flow in a direction away from the coolant egress channel 128. According to some implementations there is interposed in the coolant supply conduit 120 a coolant pump 170 that is configured to produce liquid coolant flow in the direction of the ingress channel 27 of the torch electrode 23. According to some implementations, the coolant pump 170 is located upstream the second check valve 122.

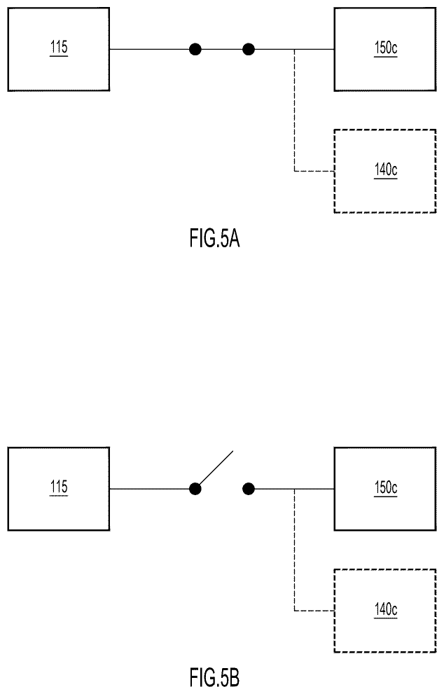

According some implementations the coolant storge tank 110 is equipped with a liquid coolant high level sensor 113 that is coupled to or resides in the tank. The sensor 113 comprises or is otherwise connected to a switch 114 that is located between an electrical power source 115 and one or both of electronic actuators 140c and 150c of control valves 140 and 150. As shown in FIG. 5A, during a coolant purging operation the switch 114 is in a closed position to permit the flow of current from the power source 115 to at least actuator 150c to maintain control valve 150 in an open position. As shown in FIG. 5B, upon a liquid coolant level in the tank 110 achieving a high threshold level, switch 114 is caused to transition to an open position to at least cease the flow of current to actuator 150c to cause control valve 150 to assume a closed position. As shown in FIGS. 5A-B, the switch 114 may also be operative to control a flow of current from the power source 115 to actuator 140c.

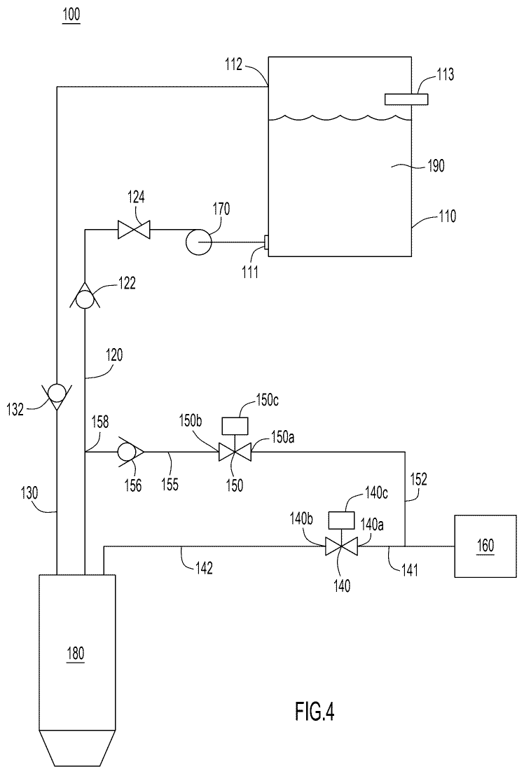

FIG. 4 depicts a plasma arc welding assembly according to another implementation wherein the first control valve 140 is configured to control the flow of process gas into the process gas flow channel 30 of torch 180 in a manner like that described above. Also like disclosed above, the second control valve 150 is disposed between third and fourth conduits, however the third conduit 152 couples the inlet 150a of the second control valve 150 to the process gas source 160 and the fourth conduit 155 couples the outlet 150b of the second control valve 150 to the coolant supply conduit 120. This implementation differs from the implementation of FIG. 3 in that the process gas delivered to the inlet 150a of the second control valve 150 does not first flow through the first control valve 140.

With continued reference to FIG. 4, during a cutting operation the first control valve 140 is maintained in an open position to deliver process gas into the arc chamber 26 of the torch 180 and the second control valve 150 is maintained closed. However, during a time period after the cutting operation has terminated and before a torch consumable is changed, the coolant pump 170 is turned off and at least the second control valve 150 is opened to cause a flow of process gas through the liquid coolant circulation system in a manner like that discussed above. That is, the process gas flows respectively through at least a portion of the coolant supply conduit 120, the ingress channel 27, the egress channel 28 and the coolant return conduit 130.

According to some implementations, upon or after the completion of the cutting operation, the first control valve 140 is closed to terminate process gas flow into the process gas flow channel 30 of the torch 180. The closing of the first control valve 140 may occur before or after the opening of the second control valve 150.

Additional implementations are disclosed in the clauses below.
Clause 1. A plasma arc cutting assembly comprising:
a torch configured to be outfitted with a detachable consumable part having disposed therein a coolant channel through which a liquid coolant flows during a plasma arc cutting operation, the coolant channel including an ingress channel through which the liquid coolant enters the consumable part and an egress channel through which the liquid coolant is directed out of the consumable part, the consumable part including an electrode having a distal end located inside a nozzle with there being an arc chamber located in a space between the electrode and nozzle, there existing a process gas flow channel that is configured to deliver a process gas into the arc chamber;
a coolant supply conduit through which the liquid coolant is delivered to the ingress channel;
a coolant return conduit through which the liquid coolant flows upon exiting the egress channel;
a pressurized process gas source containing the process gas;
a first electronic control valve located between first and second conduits, the first conduit being located between the process gas source and an inlet of the first electronic valve, the second conduit being located between an outlet of the first electronic control valve and the process gas flow channel, the first electronic control valve being configured to control the flow of process gas into the process gas flow channel; and
a second electronic control valve located between third and fourth conduits and being transitional between an open position and a closed position, the third conduit coupling the second conduit to an inlet of the second control valve, the fourth conduit coupling an outlet of the second control valve to the coolant supply conduit.
Clause 2. The plasma arc cutting assembly according to clause 1, wherein the first control valve is transitional between an open position and a closed position.
Clause 3. The plasma arc cutting assembly according to clause 1, wherein upon there being a flow of process gas through the first control valve and the second control valve being in the open position, the process gas flows respectively through at least a portion of the coolant supply conduit, the ingress channel, the egress channel, and the coolant return conduit while simultaneously flowing to the process gas flow channel of the torch and into the arc chamber.
Clause 4. The plasma arc cutting assembly according to clause 2, wherein upon each of the first and second control valves being in the open position, the process gas flows respectively through at least a portion of the coolant supply conduit, the ingress channel, the egress channel, and the coolant return conduit while simultaneously flowing to the process gas flow channel of the torch.
Clause 5. The plasma arc cutting assembly according to clause 1, further comprising;
a first check valve located in the fourth conduit that only permits flow in the direction of the coolant supply conduit;
a second check valve located in the coolant supply conduit upstream a coupling location of the fourth conduit with the coolant supply conduit, the second check valve only permitting flow in the direction of the ingress channel;
a third check valve located in the coolant return conduit, the third check valve only permitting flow in a direction away from the egress channel.
Clause 6. The plasma arc cutting assembly according to clause 1, further comprising a reservoir containing the liquid coolant, the reservoir including a liquid coolant outlet in fluid communication with the coolant supply conduit, there being interposed in the coolant supply conduit a coolant pump that is configured to produce liquid coolant flow in the direction of the ingress channel, the coolant pump being located upstream the second check valve, the reservoir also including a liquid coolant inlet in fluid communication with the coolant return conduit.
Clause 7. The plasma arc cutting assembly according to clause 6, wherein the reservoir is a tank, a liquid coolant high level sensor being coupled to or residing in the tank and configured to activate a switch upon a liquid coolant level in the tank achieving a high threshold level, when activated, the switch is operative to terminate power to one or both of the first and second electronic control valves to cease the flow of process gas into the coolant supply conduit.
Clause 8. The plasma arc cutting assembly according to clause 1, wherein the first electronic control valve is a proportional valve and the second electronic control valve is a solenoid valve.
Clause 9. The plasma arc cutting assembly according to clause 1, wherein each of the first and second electronic control valves is a solenoid valve.
Clause 10. A plasma arc cutting assembly comprising:
a torch configured to be outfitted with a detachable consumable part having disposed therein a coolant channel through which a liquid coolant flows during a plasma arc cutting operation, the coolant channel including an ingress channel through which the liquid coolant enters the consumable part and an egress channel through which the liquid coolant is directed out of the consumable part, the consumable part including an electrode having a distal end located inside a nozzle with there being an arc chamber located in a space between the electrode and nozzle, there existing a process gas flow channel that is configured to deliver a process gas into the arc chamber;
a coolant supply conduit through which the liquid coolant is delivered to the ingress channel;
a coolant return conduit through which the liquid coolant flows upon exiting the egress channel;
a pressurized plasma process gas source containing the process gas;
first and second conduits through which the process gas flows before entering the process gas flow channel, there being located between the first and second conduits a first electronic control valve that is configured to control the flow of process gas into the process gas flow channel of the torch;
third and fourth conduits, there being located between the third and fourth conduits a second electronic control valve that is transitional between an open position and a closed position, the fourth conduit coupling an outlet of the second control valve to the coolant supply conduit;
a tank containing the liquid coolant, the tank including a liquid coolant outlet in fluid communication with the coolant supply conduit, there being interposed in the coolant supply conduit a coolant pump that is configured to produce liquid coolant flow in the direction of the ingress channel, the tank also including a liquid coolant inlet in fluid communication with the coolant return conduit; and
a liquid coolant high level sensor being coupled to or residing in the tank and configured to activate a switch upon a liquid coolant level in the tank achieving a high threshold level, when activated, the switch is operative to terminate power to the second electronic control valve to cease the flow of process gas into the coolant supply conduit.
Clause 11. The plasma arc cutting assembly according to clause 10, wherein the first electronic control valve is a proportional valve and the second electronic control valve is an electromagnetic valve.
Clause 12. The plasma arc cutting assembly according to clause 10, wherein each of the first and second electronic control valves is an electromagnetic valve.
Clause 13. The plasma arc cutting assembly according to clause 10, wherein upon the second electronic control valve being in the open position, the process gas flows respectively through at least a portion of the coolant supply conduit, the ingress channel, the egress channel and the coolant return conduit.
Clause 14. The plasma arc cutting assembly according to clause 10, further comprising;
a first check valve located in the fourth conduit that only permits flow in the direction of the coolant supply conduit;
a second check valve located in the coolant supply conduit upstream a coupling location of the fourth conduit with the coolant supply conduit, the second check valve only permitting flow in the direction of the ingress channel; and
a third check valve located in the coolant return conduit, the third check valve only permitting flow in a direction away from the egress channel.
Clause 15. The plasma arc cutting assembly according to clause 14, wherein the coolant pump is located upstream the second check valve.
Clause 16. A plasma arc cutting assembly comprising:
a torch configured to be outfitted with a detachable consumable part having disposed therein a coolant channel through which a liquid coolant flows during a plasma arc cutting operation, the coolant channel including an ingress channel through which the liquid coolant enters the consumable part and an egress channel through which the liquid coolant is directed out of the consumable part, the consumable part including an electrode having a distal end located inside a nozzle with there being an arc chamber located in a space between the electrode and nozzle, there existing a process gas flow channel that is configured to deliver a process gas into the arc chamber;
a coolant supply conduit through which the liquid coolant is delivered to the ingress channel;
a coolant return conduit through which the liquid coolant flows upon exiting the egress channel;
a pressurized plasma process gas source containing the process gas;
first and second conduits through which the process gas flows before entering the process gas flow channel, there being located between the first and second conduits a first electronic control valve that is configured to control the flow of process gas into the process gas flow channel of the torch;
third and fourth conduits, there being located between the third and fourth conduits a second electronic control valve that is transitional between an open position and a closed position, the fourth conduit coupling an outlet of the second control valve to the coolant supply conduit;
a first check valve located in the fourth conduit that only permits flow in the direction of the coolant supply conduit;
a second check valve located in the coolant supply conduit upstream a coupling location of the fourth conduit with the coolant supply conduit, the second check valve only permitting flow in the direction of the ingress channel; and
a third check valve located in the coolant return conduit, the third check valve only permitting flow in a direction away from the egress channel.
Clause 17. The plasma arc cutting assembly according to clause 16, wherein the coolant pump is located upstream the second check valve.
Clause 18. A method of purging liquid coolant from a plasma arc cutting assembly, the plasma arc cutting assembly comprising:
a torch configured to be outfitted with a detachable consumable part having disposed therein a coolant channel through which the liquid coolant flows during a plasma arc cutting operation, the coolant channel including an ingress channel through which the liquid coolant enters the consumable part and an egress channel through which the liquid coolant is directed out of the consumable part, the consumable part including an electrode having a distal end located inside a nozzle with there being an arc chamber located in a space between the electrode and nozzle, there existing a process gas flow channel that is configured to deliver a process gas into the arc chamber;
a coolant supply conduit through which the liquid coolant is delivered to the ingress channel;
a coolant return conduit through which the liquid coolant flows upon exiting the egress channel;
a pressurized process gas source containing the process gas;
a first electronic control valve located between first and second conduits, the first conduit being located between the process gas source and an inlet of the first electronic valve, the second conduit being located between an outlet of the first electronic control valve and the process gas flow channel, the first electronic control valve being configured to control the flow of process gas into the process gas flow channel of the torch; and
a second electronic control valve located between third and fourth conduits and being transitional between an open position and a closed position, the third conduit coupling the second conduit to an inlet of the second control valve, the fourth conduit coupling an outlet of the second control valve to the coolant supply conduit;
the method comprising:
   terminating power to the liquid coolant pump;
   causing each of the first and second electronic control valves to assume an open position to deliver process gas respectively into the coolant supply conduit, the ingress channel, the egress channel, and the coolant return conduit to remove the liquid coolant from the coolant supply conduit, the ingress channel, the egress channel, and the coolant return conduit; and
   while purging the liquid coolant from the plasma arc cutting assembly, simultaneously delivering process gas to the process gas supply channel of the torch and into the arc chamber.
Clause 19. A method of purging liquid coolant from a plasma arc cutting assembly, the plasma arc cutting assembly comprising:
a torch configured to be outfitted with a detachable consumable part having disposed therein a coolant channel through which a liquid coolant flows during a plasma arc cutting operation, the coolant channel including an ingress channel through which the liquid coolant enters the consumable part and an egress channel through which the liquid coolant is directed out of the consumable part, the consumable part including an electrode having a distal end located inside a nozzle with there being an arc chamber located in a space between the electrode and nozzle, there existing a process gas flow channel that is configured to deliver a process gas into the arc chamber;
a coolant supply conduit through which the liquid coolant is delivered to the ingress channel;
a coolant return conduit through which the liquid coolant flows upon exiting the egress channel;
a pressurized plasma process gas source containing the process gas;
first and second conduits through which the process gas flows before entering the process gas flow channel, there being located between the first and second conduits a first electronic control valve that is configured to control the flow of process gas into the process gas flow channel of the torch;
third and fourth conduits, there being located between the third and fourth conduits a second electronic control valve that is transitional between an open position and a closed position, the fourth conduit coupling an outlet of the second control valve to the coolant supply conduit;
a tank containing the liquid coolant, the tank including a liquid coolant outlet in fluid communication with the coolant supply conduit, there being interposed in the coolant supply conduit a coolant pump that is configured to produce liquid coolant flow in the direction of the ingress channel, the tank also including a liquid coolant inlet in fluid communication with the coolant return conduit; and
a liquid coolant high level sensor being coupled to or residing in the tank and configured to activate a switch upon a liquid coolant level in the tank achieving a high threshold level, when activated, the switch is operative to terminate power to the second electronic control valve to cause the second electronic control valve to transition from the open position to the closed position to cease the flow of process gas into the coolant supply conduit;
the method comprising:
   terminating power to the liquid coolant pump;
   causing the second electronic control valve to assume an open position to deliver process gas respectively into the coolant supply conduit, the ingress channel, the egress channel, and the coolant return conduit to remove the liquid coolant from the coolant supply conduit, the ingress channel, the egress channel, and the coolant return conduit;
   upon the liquid coolant level in the tank achieving the high threshold level, activating the switch to terminate power to the second electronic control valve to cease the flow of process gas into the coolant supply conduit.

The examples disclosed herein are not suggested to limit other variations. The present disclosure is merely exemplary in nature and, thus, variations that do not depart from the spirit of the disclosure are intended to be within the scope of the present disclosure.

What is claimed is:

1. A plasma arc cutting assembly comprising:
a torch configured to be outfitted with a detachable consumable part having disposed therein a coolant channel through which a liquid coolant flows during a plasma arc cutting operation and a process gas flow channel that is configured to deliver a process gas into an arc chamber of the torch to maintain a stream of plasma;
a coolant supply conduit through which the liquid coolant is delivered to the coolant channel;
a coolant return conduit through which the liquid coolant flows upon exiting the coolant channel;
a first control valve located on a gas line that extends at least partially between a process gas source and the process gas flow channel of the torch, the first control valve being configured to control flow of process gas into the process gas flow channel, the gas line including a first conduit located downstream an outlet of the first control valve; and
a second control valve located between a second conduit and a third conduit and being transitional between an open position and a closed position, the second conduit coupling the first conduit to an inlet of the second control valve, the third conduit coupling an outlet of the second control valve to the coolant supply conduit.

2. The plasma arc cutting assembly according to claim 1, wherein the first control valve is transitional between an open position and a closed position.

3. The plasma arc cutting assembly according to claim 1, wherein upon there being a flow of process gas through the first control valve, and the second control valve being in the open position, the process gas flows respectively through at least a portion of the coolant supply conduit, the coolant channel, and the coolant return conduit while simultaneously flowing to the process gas flow channel of the torch and into the arc chamber.

4. The plasma arc cutting assembly according to claim 2, wherein upon each of the first control valve and the second control valve being in respective open positions, the process gas flows through at least a portion of the coolant supply conduit, the coolant channel, and the coolant return conduit while simultaneously flowing to the process gas flow channel of the torch.

5. The plasma arc cutting assembly according to claim 1, further comprising:
a first check valve located in the second conduit that only permits flow in a direction of the coolant supply conduit; and
a second check valve located in the coolant supply conduit upstream a coupling location of the second conduit with the coolant supply conduit, the second check valve only permitting flow in a direction of the coolant channel.

6. The plasma arc cutting assembly according to claim 5, further comprising a third check valve located in the coolant return conduit, the third check valve only permitting flow in a direction away from the coolant channel.

7. The plasma arc cutting assembly according to claim 5, further comprising:
a reservoir containing the liquid coolant, the reservoir including a liquid coolant outlet in fluid communication with the coolant supply conduit; and
a coolant pump that is configured to produce liquid coolant flow along the coolant supply conduit in the direction of the coolant channel, the coolant pump being located upstream the second check valve.

8. The plasma arc cutting assembly according to claim 7, wherein a high level sensor is coupled to or resides in the reservoir, the high level sensor being configured to activate a switch upon a liquid coolant level in the reservoir achieving a high threshold level, when activated, the switch is operative to cause one or both of the first control valve and the second control valve to cease the flow of process gas into the coolant supply conduit.

9. The plasma arc cutting assembly according to claim 1, wherein the first control valve is a proportional valve and the second control valve is a solenoid valve.

10. The plasma arc cutting assembly according to claim 1, wherein each of the first control valve and the second control valve is a solenoid valve.

11. A plasma arc cutting assembly comprising:
a torch configured to be outfitted with a detachable consumable part having disposed therein a coolant channel through which a liquid coolant flows during a plasma arc cutting operation and a process gas flow channel that is configured to deliver a process gas into an arc chamber of the torch to maintain a stream of plasma;
a coolant supply conduit through which the liquid coolant is delivered to the coolant channel;
a coolant return conduit through which the liquid coolant flows upon exiting the coolant channel;
a pressurized plasma process gas source containing the process gas;
a gas line through which the process gas flows before entering the process gas flow channel, a first control valve being disposed on the gas line and configured to control a flow of process gas into the process gas flow channel;
a first conduit and a second conduit, wherein a second control valve that is transitional between an open position and a closed position is disposed between the first conduit and the second conduit, and the second conduit couples an outlet of the second control valve to the coolant supply conduit;
a tank containing the liquid coolant, the tank including a liquid coolant outlet in fluid communication with the coolant supply conduit; and
a liquid coolant high level sensor coupled to or residing in the tank and configured to activate a switch upon a liquid coolant level in the tank achieving a high threshold level, wherein when activated, the switch is operative to cause to the second control valve to cease the flow of process gas into the coolant supply conduit.

12. The plasma arc cutting assembly according to claim 11, wherein the first control valve is a proportional valve and the second control valve is an electromagnetic valve.

13. The plasma arc cutting assembly according to claim 11, wherein each of the first control valve and the second control valve is an electromagnetic valve.

14. The plasma arc cutting assembly according to claim 11, wherein upon the second control valve being in the open position, the process gas flows through at least a portion of the coolant supply conduit, the coolant channel and the coolant return conduit.

15. The plasma arc cutting assembly according to claim 11, further comprising;
a first check valve located in the second conduit that only permits flow in a direction of the coolant supply conduit; and
a second check valve located in the coolant supply conduit upstream a coupling location of the second conduit with the coolant supply conduit, the second check valve only permitting flow in a direction of the coolant channel.

16. The plasma arc cutting assembly according to claim 15, further comprising a third check valve located in the coolant return conduit, the third check valve only permitting flow in a direction away from the coolant channel.

17. The plasma arc cutting assembly according to claim 15, wherein a coolant pump is located upstream the second check valve.

18. A method of purging liquid coolant from a plasma arc cutting assembly, the plasma arc cutting assembly comprising:
terminating power to a liquid coolant pump configured to pump, via a coolant supply conduit, a liquid coolant to a torch configured to be outfitted with a detachable consumable part that includes a coolant channel through which the liquid coolant flows during a plasma arc cutting operation and a process gas flow channel that is configured to deliver a process gas into an arc chamber of the torch to maintain a stream of plasma;
causing a first control valve, which is located on a gas line extending at least partially between a process gas source and the process gas flow channel, to assume an open position;
causing a second control valve, which is located on a conduit between the gas line and the coolant supply conduit to assume an open position, wherein when the first control valve and the second control valve are each in their open position, the process gas is delivered into at least the coolant supply conduit and the coolant channel to remove the liquid therefrom; and
while purging the liquid coolant from the plasma arc cutting assembly, simultaneously delivering process gas to the process gas supply channel of the torch and into the arc chamber.

19. The method of claim 18, further comprising:
upon a liquid coolant level in a tank containing a reservoir of the liquid coolant reaching a high threshold level, causing the second control valve to cease the flow of process gas into the coolant supply conduit.

20. The method of claim 19, further comprising:
detecting the high threshold level with a liquid coolant high level sensor that is coupled to or resides in the tank, the high level sensor being configured to activate a switch upon a liquid coolant level in the tank achieving the high threshold level, and when activated, the switch is operative to terminate power to the second control valve to cause the second control valve to transition from the open position to a closed position to cease the flow of process gas into the coolant supply conduit.
